(19) United States
(12) Patent Application Publication
(10) Pub. No.: US 2025/0350049 A1
(43) Pub. Date: Nov. 13, 2025

(54) ELECTRICAL CONNECTOR WITH AN IMPROVED FIXING MEMBER

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: KUO-CHUN HSU, New Taipei (TW); Xun Wu, Huaian (CN); Zhao-Xuan Chen, Huaian (CN); Hung-Chi Yu, New Taipei (TW)

(21) Appl. No.: 19/201,138

(22) Filed: May 7, 2025

(30) Foreign Application Priority Data
May 9, 2024 (CN) 202420997915.3

(51) Int. Cl. H01R 12/70; H01R 12/73

(52) U.S. Cl. CPC H01R 12/707; H01R 12/737

(57) ABSTRACT

An electrical connector for mounting to a circuit board includes: an insulating housing having a slot; plural terminals being retained to the insulating housing and having respective contact portions exposed to the slot; and a fixing member having an upper plate and a lower plate separate and discrete from the upper plate, the upper plate being secured to the insulting housing, the lower plate being movably coupled to the upper plate.

### BACKGROUND OF THE INVENTION

### Field of the Invention

The present invention relates generally to an electrical connector, and particularly to an electrical connector with an improved fixing member.

### Description of Related Arts

U.S. Pat. No. 11,239,609 discloses a card edge connector which includes an insulating housing, plural conductive terminals, and two fixing members arranged at two ends of the insulating housing for fixing the insulating housing to a circuit board. The fixing member has an upper vertical plate secured to the insulating housing, a lower horizontal plate for soldering to a printed circuit board, and a pair of elastic arms between the two plates. The elastic arms provide a limited floating movement of the housing and the upper vertical plate relative to the lower horizontal plate in case the insulating housing should warp during solder reflow process.

An improved electrical connector is desired.

### SUMMARY OF THE INVENTION

An object of the present invention is to provide an electrical connector with a stable structure.

To achieve the above-mentioned object, an electrical connector for mounting to a circuit board includes: an insulating housing having a slot; a plurality of terminals being retained to the insulating housing and having respective contact portions exposed to the slot; and a fixing member having an upper plate and a lower plate separate and discrete from the upper plate, the upper plate being secured to the insulting housing, the lower plate being movably coupled to the upper plate.

Other advantages and novel features of the invention will become more apparent from the following detailed description of the present embodiment when taken in conjunction with the accompanying drawings.

### BRIEF DESCRIPTION OF THE DRAWING

FIG. 1 is a perspective view of an electrical connector of the present invention;

FIG. 2 is a partial enlarged perspective view of FIG. 1;

FIG. 3 is an exploded perspective view of the electrical connector of FIG. 2;

FIG. 4 is another exploded perspective view of the electrical connector of FIG. 3;

FIG. 5 is a side view of the fixing member;

FIG. 6 is a bottom view of the fixing member; and

FIG. 7 is a perspective view of the fixing member.

### DETAILED DESCRIPTION OF THE PREFERRED EMBODIMENT

Reference will now be made to the drawing figures to describe the preferred embodiment of the present invention in detail.

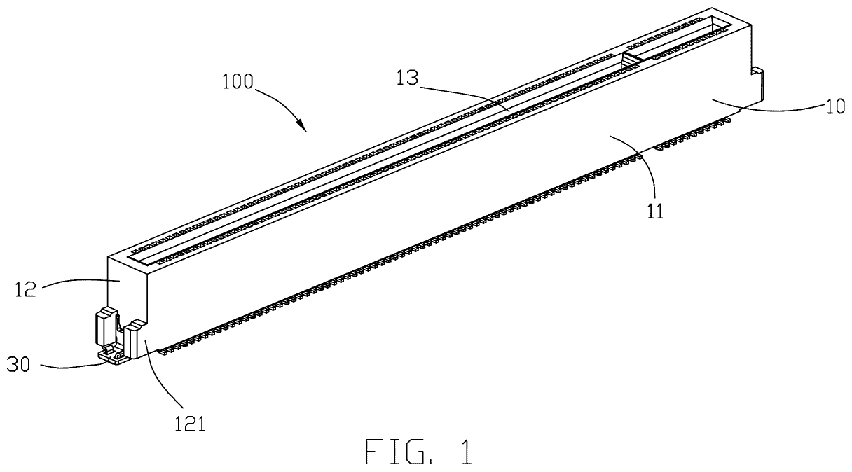

Referring to FIGS. 1-4, an electrical connector 100 of the present invention is mounted on a circuit board (not shown) and adapted for insertion with an electronic card (not shown) so as to establish an electrical connection between the circuit board and the card. The electrical connector 100 includes a longitudinal insulating housing 10 extending in a longitudinal direction, a plurality of terminals 20 retained in the insulating housing 10, and two fixing members 30 fixed at both longitudinal ends of the insulating housing 10. The insulating housing 10 has two opposite side walls 11 extending in the longitudinal direction, two end walls 12 connected to the longitudinal ends of the two side walls 11, and a mating slot 13 located between the two side walls 11. The terminals 20 are arranged on the two side walls 11. Each terminal 20 has a contact portion 21 extending to the mating slot 13 and a soldering tail 22 extending downward out of the insulating housing 10. The end wall 12 has a retaining groove 120. The fixing member 30 comprises an upper fixing plate 31 and a lower fixing plate 32. An upper end of the upper fixing plate 31 is retained in the retaining groove 120, an upper end of the lower fixing plate 32 is assembled to a lower end of the upper fixing plate 31. The lower end of the upper fixing plate and a lower end of the lower fixing plate are to be soldered to the circuit board. The upper and lower fixing plates are connected floatingly before being soldered. In other embodiments, the electrical connector can only have one fixing member 30 arranged at any end wall 12.

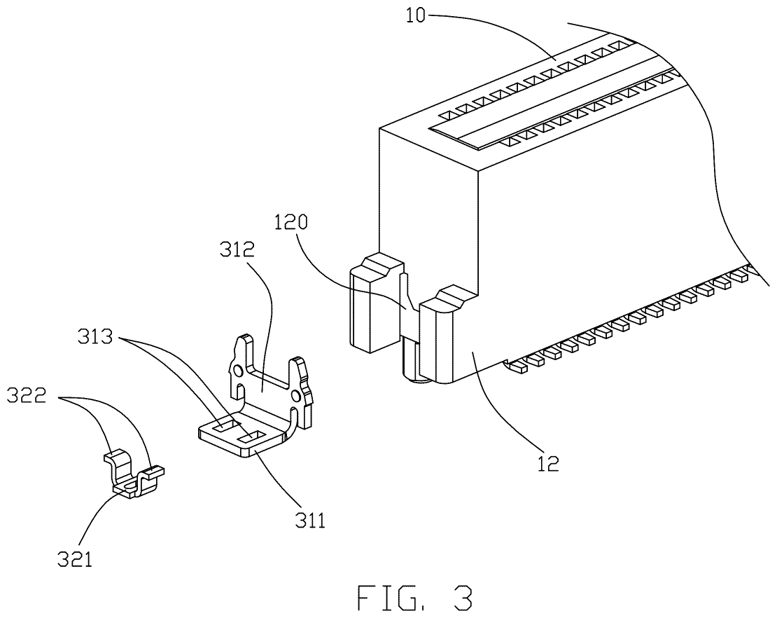

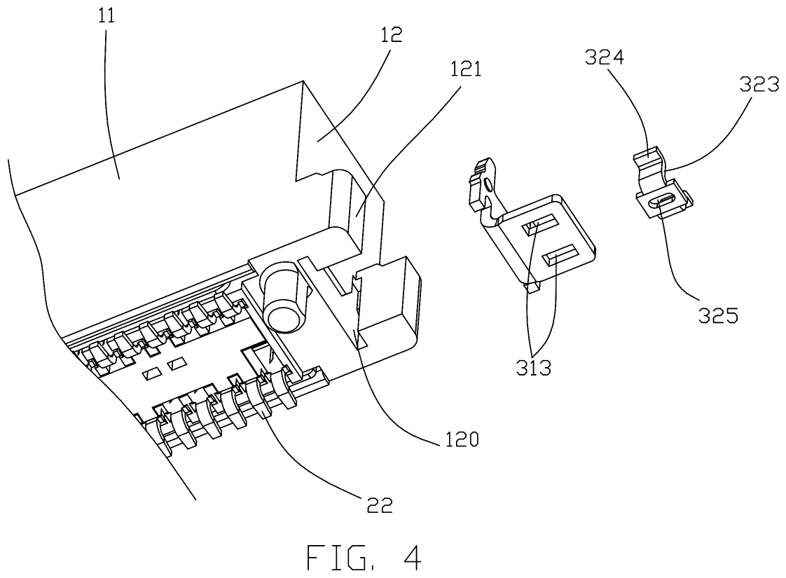

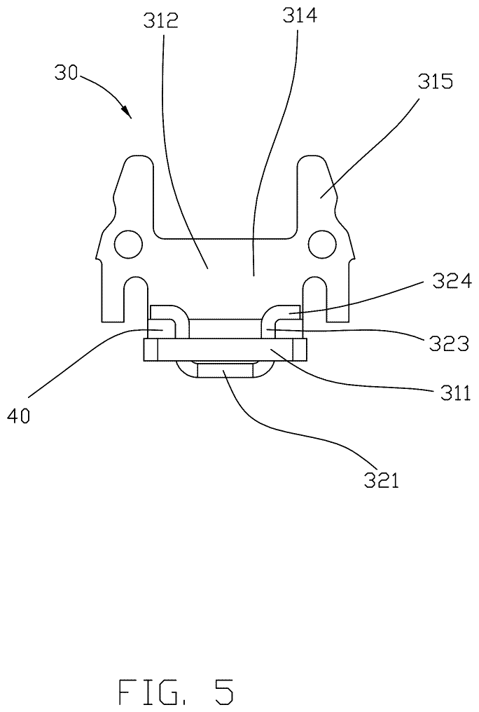

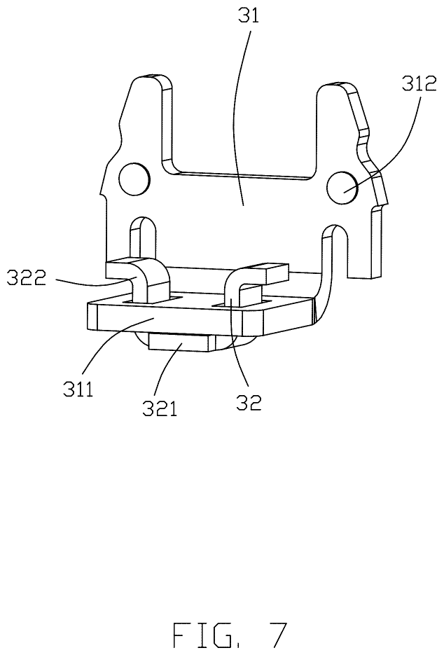

Referring to FIGS. 3-4, the upper fixing plate 31 comprises a first soldering portion 311 and an inserting portion 312 bending and extending upward from the first soldering portion 311. The lower fixing plate 32 comprises a second soldering portion 321 and two connecting arms 322 bending and extending upward from both ends of the second soldering portion 321. The retaining groove 120 opens downward, and the inserting portion 312 is fixed in the retaining groove 120 from bottom to top. The second soldering portion 321 is arranged below the first soldering portion 311. The first soldering portion and second soldering portion are soldered to the circuit board. Before being soldered, the connecting arm 322 is connected to the first soldering portion 311 in a floatable manner. The first soldering portion 311 extends horizontally and has two through holes 313 extending in an up-down direction. Each of the connecting arms 322 has a vertical portion 323 extending upward from the second soldering portion 321 and a horizontal portion 324 extending horizontally from the vertical portion 323. The vertical portion 323 passes through the corresponding through hole 313 from bottom to top firstly, and then an end of the connecting arm 322 is bent into the horizontal portion 324 so that the horizontal portion 324 is buckled on the first soldering portion 311. As shown in FIGS. 5-7, in the up-down direction, a length of the vertical portion 323 is longer than a thickness of the first soldering portion 311, and a floating gap 40 of the upper fixing plate and lower fixing plate is formed between the second soldering portion 321 and the horizontal portion 324. When the soldering tail 22 of the terminal 20 is soldered to the circuit board, since the fixing member 30 has the floating gap 40, the relative position of the upper fixing plate 31 and the lower fixing plate 32 can be adjusted according to the thermal warping of the insulating housing 10, and then the first soldering portion and the second soldering portion are soldered to the circuit board. This can prevent empty soldering, thereby optimizing the flatness of the insulating housing 10, especially when the size of the insulating housing is small, and can increase the structural stability of the electrical connector 100. After being soldered, a gap is formed between the first soldering portion 311 and an upper end of the connecting arm 322 or the second soldering portion 321 in the up-down direction.

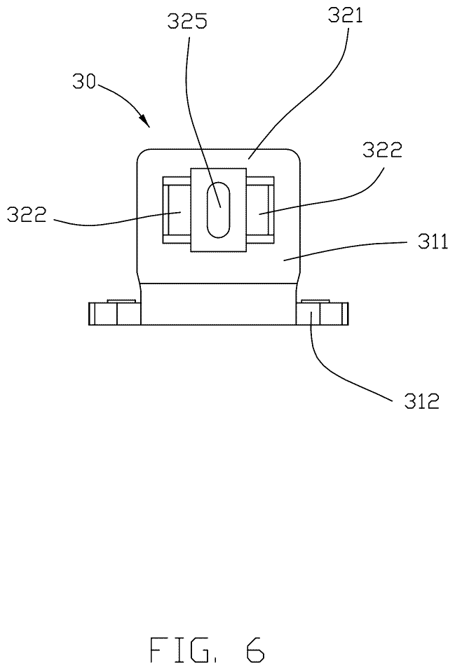

Referring to FIGS. 3-4, the upper fixing plate 31 is formed by bending a first metal sheet, the lower fixing plate 32 is formed by bending a second metal sheet, and the thickness of the second metal sheet is smaller than that of the first metal sheet. In this embodiment, the thickness of the first metal sheet is 0.4 mm, and the thickness of the second metal sheet is 0.25 mm. The second soldering portion 321 extends horizontally and has a flow hole 325 penetrating in the up-down direction. An area of the second soldering portion 321 is smaller than an area of the first soldering portion 311, and the first soldering portion 311 exposes to the flow hole 325. The flow hole 325 is used to guide the flow of solder paste (not shown) between the upper fixing plate 31 and the lower fixing plate 32. As shown in FIG. 6, the flow hole 325 is disposed between the two through holes 313.

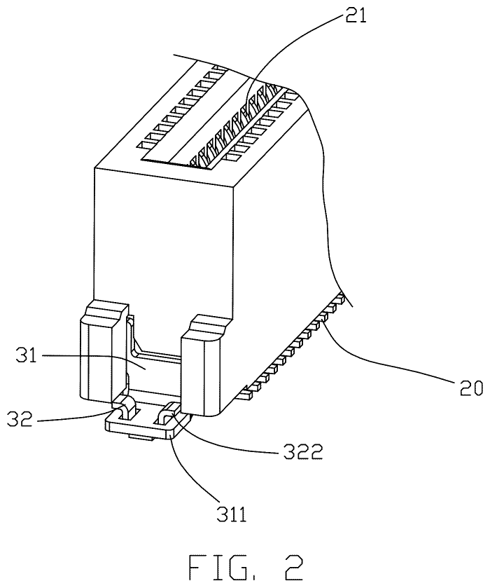

Referring to FIGS. 2-5, the end wall 12 has a convex block 121 protruding longitudinally, and the retaining groove 120 is recessed upward from a bottom face of the convex block 121. The inserting portion 312 of the upper fixing plate 31 has a main body 314 connected to the first soldering portion 311 and two barbs 315 respectively arranged on both sides of the main body 314, and the two barbs 315 are respectively fixed on both sides of the retaining groove 120. A gap is arranged between the barb 315 and the main body 314, which may make the barb 345 elastic. Therefore, the upper fixing plate 31 can also be connected to the insulating housing 10 floatingly, which can further resist the warping of the insulating housing 10 and maintain the structural stability of the electrical connector 100.

The above-mentioned embodiments are only preferred embodiments of the present invention, and should not limit the scope of the present invention, any simple equivalent changes and modifications made according to the claims of the present invention and the contents of the description should still belong to the present invention.

1. An electrical connector for mounting on a circuit board comprising:
an insulating housing extending in a longitudinal direction and having two opposite side walls extending in the longitudinal direction, two end walls connected to the two side walls, and a mating slot located between the two side walls;
a plurality of terminals retained in the insulating housing and arranged on the two side walls, the terminals comprising contact portions extending to the mating slot; and
two fixing members located at two longitudinal ends of the insulating housing;
wherein the end wall has a retaining groove, the fixing member comprises an upper fixing plate and a lower fixing plate, an upper end of the upper fixing plate is retained in the retaining groove, an upper end of the lower fixing plate is assembled to a lower end of the upper fixing plate, the lower end of the upper fixing plate and a lower end of the lower fixing plate are to be soldered to the circuit board, and the upper and lower fixing plates are connected floatingly before being soldered to the circuit board.

2. The electrical connector as claimed in claim 1, wherein the upper fixing plate comprises a first soldering portion and an inserting portion bending and extending upward from the first soldering portion, the lower fixing plate comprises a second soldering portion and connecting arms bending and extending upward from both ends of the second soldering portion, the inserting portion is fixed in the retaining groove, the second soldering portion is arranged below the first soldering portion, the first soldering portion and the second soldering portion are used to be soldered to the circuit board, and the connecting arm is connected to the first soldering portion in a floatable manner before being soldered.

3. The electrical connector as claimed in claim 2, wherein the first soldering portion extends horizontally and has two through holes extending in an up-down direction, each of the connecting arms has a vertical portion extending upward from the second soldering portion and a horizontal portion extending horizontally from the vertical portion, the vertical portion passes through the corresponding through hole, and the horizontal portion is buckled on the first soldering portion.

4. The electrical connector as claimed in claim 3, wherein in the up-down direction, a length of the vertical portion is longer than a thickness of the first soldering portion, and a floating gap of the upper fixing plate and the lower fixing plate is formed between the second soldering portion and the horizontal portion.

5. The electrical connector as claimed in claim 3, wherein the upper fixing plate is formed by bending a metal sheet, and the thickness of the metal sheet is 0.4 mm.

6. The electrical connector as claimed in claim 3, wherein the lower fixing plate is formed by bending a metal sheet, and the thickness of the metal sheet is 0.25 mm.

7. The electrical connector as claimed in claim 4, wherein the second soldering portion extends horizontally and has a flow hole penetrating in the up-down direction.

8. The electrical connector as claimed in claim 7, wherein an area of the second soldering portion is smaller than an area of the first soldering portion, and the first soldering portion exposes to the flow hole.

9. The electrical connector as claimed in claim 7, wherein the flow hole is disposed between the two through holes.

10. The electrical connector as claimed in claim 7, wherein the end wall has a convex block protruding longitudinally, and the retaining groove is recessed upward from a bottom face of the convex block, the inserting portion of the upper fixing plate has a main body connected to the first soldering portion and two barbs respectively arranged on both sides of the main body, and the two barbs are respectively fixed on both sides of the retaining groove.

11. An electrical connector adapted for being mounted on a circuit board, comprising:
an elongate insulating housing having two opposite side walls, two end walls with a retaining groove, and a mating slot located between the two side walls;
a plurality of terminals retained in the insulating housing and arranged on the two side walls, the terminals having contact portions extending to the mating slot; and
a fixing member fixed on the end wall;
wherein the fixing member has an upper fixing plate and a lower fixing plate, the upper fixing plate is retained to the retaining groove and has a first soldering portion, the lower fixing plate is assembled with the upper fixing plate in a floatable manner and has a second soldering portion.

12. The electrical connector as claimed in claim 11, wherein an upper end of the upper fixing plate is retained in the retaining groove, an upper end of the lower fixing plate is assembled with a lower end of the upper fixing plate.

13. The electrical connector as claimed in claim 12, wherein the upper fixing plate has the first soldering portion and an inserting portion bending and extending upward from the first soldering portion, the lower fixing plate has the second soldering portion and connecting arms bending and extending upward from both ends of the second soldering portion, the inserting portion is fixed in the retaining groove, the second soldering portion is dispose below the first soldering portion, the connecting arm is connected to the first soldering portion in the floatable manner.

14. The electrical connector as claimed in claim 13, wherein the first soldering portion extends horizontally and has two through holes extending in an up-down direction, each of the connecting arms has a vertical portion extending upward from the second soldering portion and a horizontal portion extending horizontally from the vertical portion, the vertical portion passes through the corresponding through hole, and the horizontal portion is buckled on the first soldering portion.

15. The electrical connector as claimed in claim 14, wherein in the up-down direction, a length of the vertical portion is longer than a thickness of the first soldering portion, and a floating gap is formed between the second soldering portion and the horizontal portion.

16. The electrical connector as claimed in claim 15, wherein the upper fixing plate is formed by bending a first metal sheet, the lower fixing plate is formed by bending a second metal sheet, and the thickness of the second metal sheet is smaller than that of the first metal sheet.

17. The electrical connector as claimed in claim 15, wherein each of the end walls is disposed with the fixing member.

18. The electrical connector as claimed in claim 15, wherein the second soldering portion extends horizontally and has a flow hole penetrating in the up-down direction.

19. The electrical connector as claimed in claim 18, wherein an area of the second soldering portion is smaller than that of the first soldering portion, and the first soldering portion exposes to the flow hole.

20. An electrical connector for mounting to a circuit board, comprising:
an insulating housing having a slot;
a plurality of terminals being retained to the insulating housing and having respective contact portions exposed to the slot; and
a fixing member having an upper plate and a lower plate separate and discrete from the upper plate, the upper plate being secured to the insulting housing, the lower plate being movably coupled to the upper plate.
